(19) United States
(12) Patent Application Publication
(10) Pub. No.: US 2025/0330737 A1
(43) Pub. Date: Oct. 23, 2025

(54) Wearable power supply for wireless earbuds

(71) Applicant: Wearable Power Bank Technology Co., Ltd., Shenzhen (CN)

(72) Inventor: Feng Liu, Shenzhen (CN)

(21) Appl. No.: 18/642,856

(22) Filed: Apr. 23, 2024

(30) Foreign Application Priority Data
Feb. 23, 2023 (CN) 2023202978615

(51) Int. Cl. H04R 1/10

(52) U.S. Cl. CPC H04R 1/1025; H04R 1/1016; H04R 2201/10; H04R 2420/07

(57) ABSTRACT

A wearable power supply for AirPods® wireless earbuds includes two charging heads for charging the AirPods® wireless earbuds, a charging body neck brackets, and connecting leads. The charging body is connected to the neck brackets; an outer part of each of the neck brackets is a silicone housing. An inner part of each of the neck brackets is a memory steel wire. The two charging heads are connected to the charging body through the connecting leads passing through the neck brackets. Each of the two charging head defines an earbud communication microphone channel. The charging head is provided with a first printed circuit board welded with charging contact terminals and a second printed circuit board welded with a charging indicator lamp. The charging contact terminals are configured to connect to charging contact points of the AirPods® wireless earbud.

### TECHNICAL FIELD

The present disclosure relates to the technical field of smart wearable electronic devices, in particular to a wearable power supply for AirPods® wireless earbuds.

### BACKGROUND

At present, a large number of electronic consumer goods result in a large amount of electronic waste. Since an internal battery of AirPods® wireless earbuds is not detachable, when the internal battery is charged and discharged for a certain number of times, new AirPods® wireless earbuds need to be purchased, which results in electronic waste. Due to a low battery capacity of the AirPods® wireless earbuds, the AirPods® wireless earbuds need to be charged and discharged for many times every day, and a battery life of the AirPods® wireless earbuds is extremely short, resulting in it impossible to continue using the earbuds due to battery aging.

The charging of existing AirPods® wireless earbuds is mainly completed by an Apple charging case. Chinese patent with the publication number of CN109195046A discloses an earbud charging case, disadvantages of using the charging case to charge earbuds are as follows: the earbuds must be placed in the charging case during a charging process, so that the earbuds cannot be used during the charging process, and the earbuds cannot be charged when being used. Third-party chargers available on the market are also in a form of charging bases, which also have the problem that charging and use of the earbuds cannot be achieved simultaneously.

In addition, the AirPods® wireless earbuds often fall off due to their small size and unstable wearing. There are silicone straps for the AirPods® wireless earbuds on the market to solve this problem. But the silicone straps do not have a function of charging the AirPods® wireless earbuds. Therefore, when battery power of the AirPods® wireless earbuds is low, a silicone strap for the AirPods® wireless earbuds needed to be detached, the AirPods® wireless earbuds are placed in a charging case for charging, the AirPods® wireless earbuds are taken out from the charging case after charging, and the silicone strap is matched with the straps again. The entire process is very cumbersome and inconvenient. More importantly, when an anti-lost rope on the market is inserted into the earbuds, a sensing button on the AirPods® wireless earbuds cannot be triggered, thereby making earbud buttons unusable.

To avoid the above technical problems, it is necessary to provide a wearable power supply for AirPods® wireless earbuds to overcome the defects in the related art.

### SUMMARY

A purpose of the present disclosure is to provide a wearable power supply for AirPods® wireless earbuds, and the wearable power supply aims to solve the defects in the background.

A wearable power supply for AirPods® wireless earbuds is provided, which includes a charging body, neck brackets, and connecting leads. The charging body is connected to the neck brackets; an outer part of each of the neck brackets is a silicone housing; an inner part of each of the neck brackets is a memory steel wire; and the two charging heads are connected to the charging body through the connecting leads passing through the neck brackets.

Each of the two charging heads defines a structural cavity and an earbud communication microphone channel. The structural cavities of the two charging heads are configured to insert the AirPods® wireless earbuds.

Each of the two charging heads includes a structural body, charging contact terminals, a first printed circuit board, a second printed circuit board, a charging indicator lamp, and a dust-proof screen. The structural body includes a silicone sleeve, a first connector, a second connector, and a plastic base.

The charging contact terminals are welded on the first printed circuit board. The first printed circuit board is disposed on an upper end of the second connector. The charging contact terminals insert into an installing position of the first connector, and the charging contact terminals are configured to be connected to charging contact points of the respective AirPods® wireless earbud. The charging indicator lamp is welded on the second printed circuit board, and the second printed circuit board is disposed on a lower end of the second connector and located inside the second connector. An end of each of the connecting leads extends into a corresponding one of the two charging heads. A welding wire of each of the connecting leads is welded to the first printed circuit board and the second printed circuit board of the corresponding charging head. The other end of each of the connecting leads is connected to a printed circuit control board of the charging body to charge a corresponding one of the AirPods® wireless earbuds.

The first connector defines two first sound channel through-holes. The two first sound channel through-holes are configured to be connected to a microphone of the corresponding AirPods® wireless earbud. The second connector defines two second sound channel through-holes, and the two second sound channel through-holes are directly connected to the two first sound channel through-holes respectively. The two second sound channel through-holes extend to a lower part of the second connector to define sound channel ports respectively. The sound channel ports are matched with the dust-proof screen. The plastic base defines a third sound channel through-hole, and the sound channel ports are directly connected to the third sound channel through-hole. The two first sound channel through-holes, the two second sound channel through-holes, and the third sound channel through-hole are interconnected to define the earbud communication microphone channel.

In an embodiment, the first connector is disposed below the silicone sleeve and shaped by a mold. An inside of the silicone sleeve and an inside of the first connector together define the structural cavity configured to insert the respective AirPods® wireless earbud. An upper opening of the silicone sleeve defines a thin silicone opening position and a thick silicone opening position. The thin silicone opening position is configured to correspond to an earbud sensing button. The thick silicone opening position is configured to enhance insertion of the respective AirPods® wireless earbud.

In an embodiment, the upper end of the second connector defines a first printed circuit board installing position, and the lower end of the second connector defines a second printed circuit board installing position located inside the second connector.

In an embodiment, the plastic base further defines a light guiding position corresponding to the charging indicator lamp welded on the second printed circuit board.

In an embodiment, the charging body includes the printed circuit control board, a battery, power display lights, a charging button, a charging interface, and an alarm. The power display lights, the charging button, the charging interface, and the alarm are disposed on the printed circuit control board. The printed circuit control board is electrically connected to the battery.

In an embodiment, a usage method of the wearable power supply is to wear the wearable power supply on a neck. A material of the memory steel wire is titanium alloy with a memory function. The memory steel wire is configured to combine with a lever fulcrum on a back of the neck according to human engineering, thereby achieve the usage method of the wearable power supply.

In an embodiment, the alarm is a buzzer or a vibration motor.

In an embodiment, models of the AirPods® wireless earbuds include AirPods1® (i.e., first generation), AirPods2® (i.e., second generation), AirPods3® (i.e., third generation), AirPods Pro1® (i.e., first generation), and AirPods Pro2® (i.e., second generation), but not limited to these wireless earbuds.

Compared with the related art, wearable power supply of the present disclosure has the following beneficial effects.

The wearable power supply for the AirPods® wireless earbuds provided by the present disclosure can solve the problems that single use time of the AirPods® wireless earbuds is short and cannot be charged while using them. The wearable power supply can solve the problem of AirPods® wireless earbuds rely on a charging case for passive charging, the wearable power supply can reduce the charging frequency of the earbuds and improve a battery life of the earbuds. The wearable power supply provides anti-lost alarm function for the AirPods wireless earbuds. The wearable power supply provides a microphone channel design for calling the AirPods® wireless earbuds under a charging condition. The wearable power supply provides a silicone sleeve design for the charging heads, and thus sensing buttons of the AirPods® wireless earbuds can be used normally. The wearable power supply solves the problem that the AirPods® wireless earbuds are easy to fall off easily when being worn during exercise; The wearable power supply simultaneously supports the use of the models of the AirPods® wireless earbuds including AirPods1®, AirPods2®, AirPods3®, AirPods Pro1®, and AirPods Pro2®.

### BRIEF DESCRIPTION OF DRAWINGS

FIG. 1 illustrates a structural schematic diagram of a wearable power supply of the present disclosure.

FIG. 2 illustrates an exploded schematic diagram of a charging head of the wearable power supply.

FIG. 3 illustrates a schematic diagram of an internal structure of a charging body of the wearable power supply.

FIG. 4 illustrates an installation schematic diagram of a second connector of the charging head and a first printed circuit board of the wearable power supply.

FIG. 5 illustrates an installation schematic diagram of the second connector of the charging head and a second printed circuit board of the wearable power supply.

FIG. 6 illustrates another installation schematic diagram of the second connector of the charging head and the first printed circuit board of the wearable power supply.

FIG. 7 illustrates a structural schematic diagram of the charging head of the wearable power supply.

FIG. 8 illustrates a structural schematic diagram of the charging body and neck brackets of the wearable power supply.

### DESCRIPTION OF REFERENCE NUMERALS

A—wearable power supply; 100—charging head; 101—structural body; 1011—silicone sleeve; 1012—first connector; 1021—first sound channel through-hole; 1022—second sound channel through-hole; 1024—sound channel port; 10131—first printed circuit board installing position; 10132—second printed circuit board installing position; 1014—plastic base; 1023—third sound channel through-hole; 10141—light guiding position; 102—charging contact terminal; 103—first printed circuit board; 104—second printed circuit board; 105—charging indicator lamp; 106—dust-proof screen; 107—structural cavity; 108—thin silicone opening position; 109—thick silicone opening position; 200—connecting lead; 201—welding wire; 300—neck bracket; 301—memory steel wire; 302—silicone housing; 400—charging body; 401—battery; 402—printed circuit control board; 403—power display light; 404—charging button; 405—charging interface; 406—alarm.

### DETAILED DESCRIPTION OF EMBODIMENTS

In order to make the purpose, technical solutions, and advantages of the present disclosure clearer, the following is a further detailed explanation of the present disclosure in conjunction with drawings and embodiments. It should be understood that specific embodiments described here are only intended to explain the present disclosure and are not intended to limit the present disclosure.

The following provides a detailed description of specific implementation of methods the present disclosure based on specific embodiments.

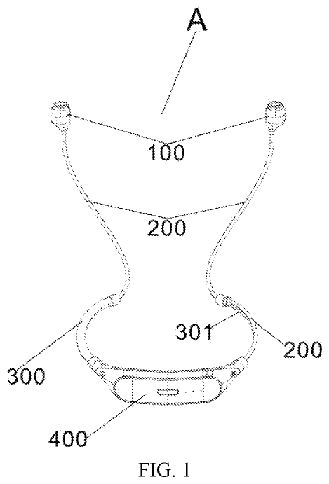

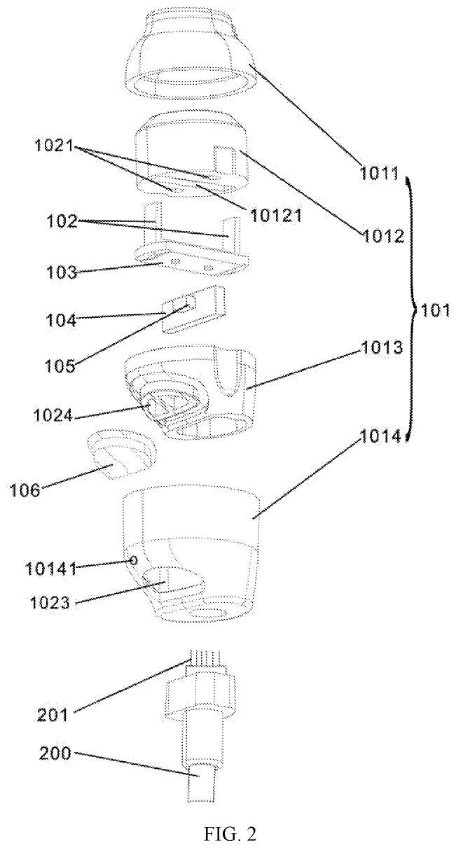

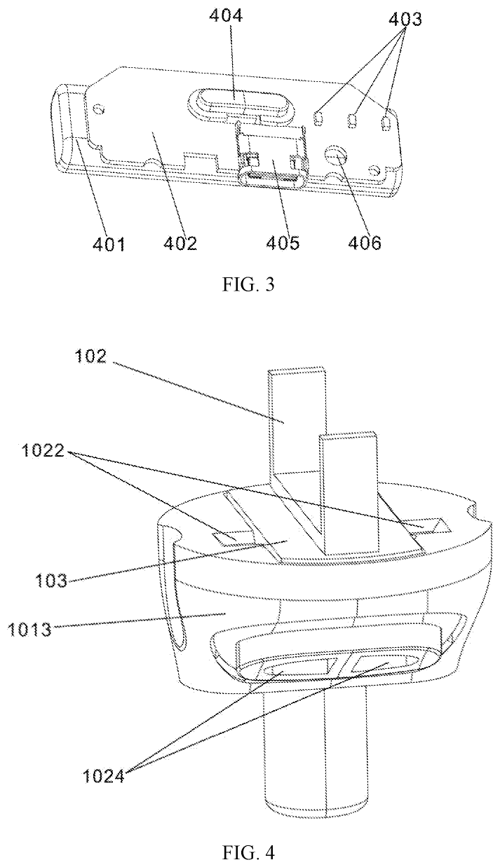

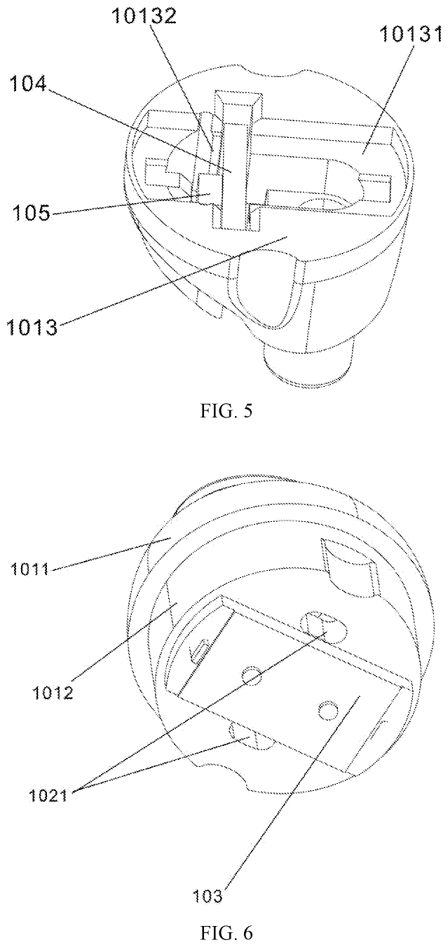

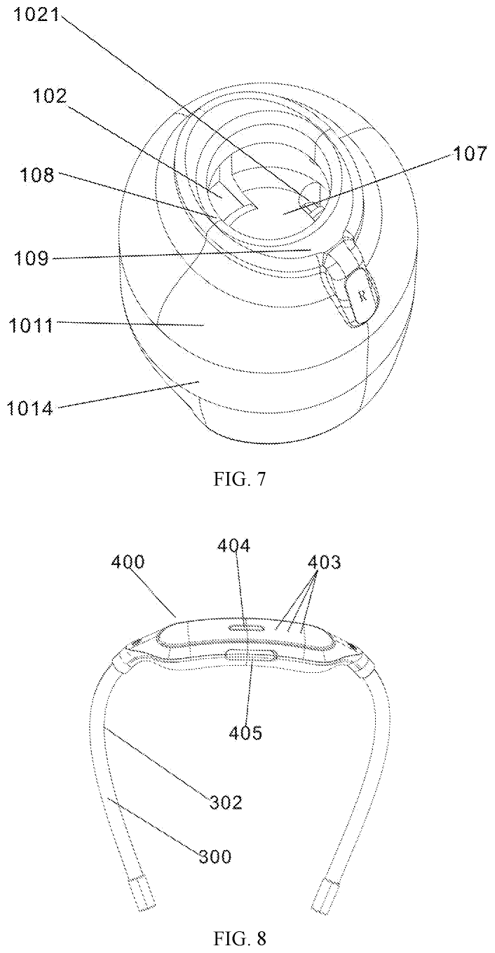

As illustrated in FIG. 1 to FIG. 8, a wearable power supply for AirPods® wireless earbuds includes two charging heads 100 for charging the AirPods® wireless earbuds, a charging body 400, neck brackets 300, and connecting leads 200. The charging body 400 is connected to the neck brackets 300. An outer part of each of the neck brackets 300 is a silicone housing 302, and an inner part of each of the neck brackets 300 is a memory steel wire 301. The two charging heads 100 are connected to the charging body 400 through the connecting leads 200 passing through the neck brackets. Each of the two charging heads 100 defines a structural cavity 107 and an earbud communication microphone channel. The structural cavities 107 of the two charging heads 100 are configured to insert the AirPods® wireless earbuds.

In an embodiment, each of the two charging heads 100 includes a structural body 101, charging contact terminals 102, a first printed circuit board 103, a second printed circuit board 104, a charging indicator lamp 105, and a dust-proof screen 106. The structural body 101 includes a silicone sleeve 1011, a first connector 1012, a second connector 1013, and a plastic base 1014. The charging contact terminals 102 are welded on the first printed circuit board 103. The charging contact terminals 102 extend into the first connector one 1012. The first connector 1012 extends into the silicone sleeve 1011. Inner space of the silicone sleeve 1011 is the structural cavity 107 for inserting a corresponding one of the AirPods® wireless earbuds. After the corresponding AirPods® wireless earbud is inserted, charging contact points of the corresponding AirPods® wireless earbud contact with the charging contact terminals 102 inside the first connector 1012. The charging indicator lamp 105 is welded on the second printed circuit board 104. A welding wire 201 of each of the connecting leads 200 is welded to the first printed circuit board 103 and the second printed circuit board 104. The other end of each of the connecting leads 200 is connected to a printed circuit control board 402 of the charging body 400 to charge the corresponding AirPods® wireless earbud. In an embodiment, the charging indicator lamp 105 is a light-emitting diode (LED) indicator lamp.

The first connector 1012 defines two first sound channel through-holes 1021. The two first sound channel through-holes 1021 are connected to a microphone of the corresponding AirPods® wireless earbud. The second connector 1013 defines two second sound channel through-holes 1022, and the two second sound channel through-holes 1022 are directly connected to the two first sound channel through-holes 1021 respectively. The two second sound channel through-holes 1022 extend to a lower part of the second connector 1013 to define sound channel ports 1024 respectively. The sound channel ports 1024 are matched with the dust-proof screen 106. The plastic base 1014 defines a third sound channel through-hole 1023, and the sound channel ports 1024 are directly connected to the third sound channel through-hole 1023. The two first sound channel through-holes 1021, the two second sound channel through-holes 1022, and the third sound channel through-hole 1023 are interconnected to define the earbud communication microphone channel.

The charging body 400 includes the printed circuit control board 402, a battery 401, power display lights 403, a charging button 404, a charging interface 405, and an alarm 406. The power display lights 403, the charging button 404, the charging interface 405, and the alarm 406 are disposed on the printed circuit control board 402. The printed circuit control board 402 is electrically connected to the battery 401.

In an embodiment of the present disclosure, the printed circuit control board 402 of the charging body 400 is provided with an AirPods® earbud insertion and extraction recognition function program, an AirPods® earbud charging protection function, and an AirPods® earbud reverse contact automatic recognition function program. There is also a control function program in the printed circuit control board 402 for charging the AirPods® wireless earbuds.

In the present disclosure, in order to solve the problems of short single use time of the AirPods® wireless earbuds and inability to charge the AirPods® wireless earbuds while in use, and to improve the problem of rapid aging of the battery 401, the charging body 400 provided in the present disclosure is connected to the two charging head 100 through the connecting leads 200, and the charging contact terminals 102 inside the two charging heads 100 contact with the charging contact points of the corresponding AirPods® wireless earbud, thereby realizing the charging of the AirPods® wireless earbud. When it is needed to use the wearable power supply, the charging of the AirPods® wireless earbud can be achieved by simply inserting the AirPods® wireless earbud into the structural cavity 107 of the charging head 100.

By using a method of the present disclosure to charge the AirPods® wireless earbud, the charging of the AirPods® wireless earbud can be manually controlled by the charging button 404. The AirPods® wireless earbud can be charged when the power of the AirPods® wireless earbud is low, so that a situation that the AirPods® wireless earbud is forced to be charged after being put back into a charging case after each call can be prevented, the charging frequency of the AirPods® wireless earbud is reduced, and a service life of the AirPods® wireless earbud is improved. The wearable power supply of the present disclosure can solve the problem that the AirPods® charging case cannot actively control the charging of the AirPods® wireless earbud. For example, a condition that the wireless earbud has high battery power, but the charging case still automatically and passively charges the AirPods® wireless earbud as long as the AirPods® wireless earbud is put into the charging case. The high-frequency charging makes the battery to be easily and rapidly aged, and the service life of the AirPods® wireless earbud is shortened.

In order to achieve the anti-lost and alarm protection functions of the AirPods® wireless earbud, the present disclosure provides a silicone sleeve design for the charging head 100, which effectively protects the wireless earbuds from loss while charging the wireless earbuds. At the same time, by monitoring the charging contact points of the wireless earbud, it is determined whether the wireless earbud is detached from the charging head 100 and whether the charging contact points are in good contact. When the charging contact points are detected to be poor, an alarm prompt is immediately triggered, and the alarm 406 set in the printed circuit control board 402 emits a prompt (or a buzzing sound or vibration). At the same time, due to the connection between the charging indicator lamp 105 set on the second printed circuit board 104 of the charging head 100 and the printed circuit control board 402 of the charging body 400, the printed circuit control board 402 can control the charging indicator lamp 105 to flash and indicate a contact situation of the wireless earbud, making it more convenient to provide anti-lost prompts for the wireless earbud.

A patent with an application number of CN202222495627.1 (Corresponding to publication number of CN218124366U) discloses a two-point contact charging positive and negative pole determination and a charging protection circuit, in which the AirPods® wireless earbud charging contact automatic recognition technology and reverse recognition charging technology are designed, solving the problem of charging protection for AirPods® wireless earbud without breaking the earbud. In the embodiment, when the AirPods® wireless earbuds are inserted into the charging head 100, a chip of the printed control board 402 quickly recognizes positive and negative pole directions of the charging contact points of the earbud, and then the charging of the earbud is started according to positions where the positive and negative poles are inserted. Even if the positive and negative pole contact points are in opposite directions, when the earbud are inserted into the charging head 100, the present disclosure can still achieve automatic charging of the earbud inserted into the charging head 100.

In order to solve the problem of not affecting the use of the microphone of the AirPods® wireless earbud under the charging condition, the present disclosure designs the earbud communication microphone channel inside the charging head 100 and installs the dust-proof screen 106 to ensure that the wireless earbud is not affected during microphone calls.

In order to solve the problem that a sensing button of the AirPods® wireless earbud cannot be used normally when a charging head is covered by a silicone sleeve, the present disclosure provides a thin silicone opening position 108 and a hick silicone mouth position 109 in positions corresponding to the silicone sleeve 1011 of the charging head 100 and the sensing button of the AirPods® earbud (i.e., AirPods3®, AirPods Pro1®, and AirPods Pro2®). Specifically, the thin silicone opening position 108 ensures that the sensing button of the AirPods® wireless earbud can be used normally, especially the sliding sensing of volume adjustment of the AirPods Pro2® can be used normally. The thick silicone opening position 109 is configured to enhance the insertion stability the AirPods® wireless earbud.

To solve the problem that the AirPods® wireless earbud is easy to fall off during sports, the present disclosure uses a lever fulcrum on a back of the neck as a mechanical force support point based on human engineering. The silicone housing 302 of the neck bracket 300 is in a curve shape of the neck. An adhesive force generated by a friction force between the silicone and the neck skin and a rebound force of the memory steel wire 301 counteracts a falling force of the lever fulcrum on the neck, and thus the problem of unstable wearing can be solved. In addition, the wearable power supply has less pressure on the neck, is not easy to be moved or deformed, and is simple and reliable to wear.

In order to simultaneously support the models of AirPods® wireless earbuds including AirPods1®, AirPods2®, AirPods3®, AirPods Pro1®, and AirPods Pro2®, when the charging contact terminals 102 inside the charging head 100 of the present disclosure contact with the charging contact points of the AirPods® wireless earbud, the structural cavity 107 of the wearable power supply ensures that charging contact points of the AirPods® wireless earbuds with different models can contact with corresponding charging contact terminals 102, ensuring that the AirPods® wireless earbuds can be charged and automatically recognized for earbud insertion and extraction detection. The present disclosure sets power display lights 403, the charging button 404, the charging interface 405, the battery 401, and the charging indicator lamp 105 on the charging body 400, which allows users to know a power level of the wearable power supply and charge it at any time. Users can freely charge the earbuds based on a power level of the earbuds. At the same time, the charging indicator lamp 105 provides feedback on a charging status of the earbuds, greatly reducing the charging number of the earbuds and improving the service life of the earbuds. Furthermore, the operation of wearable power supply is simple and convenient.

The wearable power supply of the present disclosure can be used for AirPods® earbuds, such as AirPods1®, AirPods2®, AirPods3®, AirPods Pro1®, and AirPods Pro2®, but not limited to these wireless earbuds.

The above embodiments are only exemplary embodiments of the present disclosure and are not intended to limit it. Any modifications, equivalent replacements, and improvements made within the spirit and principles of the present disclosure should be included within a scope of protection of the present disclosure.

In addition, it should be understood that although the specification is described according to the implementation methods, not each implementation method only includes an independent technical solution. This description in the specification is for clarity only. Those skilled in the art should treat the specification as a whole, and the technical solutions in each implementation method can be appropriately combined to form other implementation methods that can be understood by those skilled in the art.

What is claimed is:

1. A wearable power supply for wireless earbuds, comprising: two charging heads (100), a charging body (400), neck brackets (300), and connecting leads (200); and the two charging heads (100) being configured to charge the wireless earbuds, respectively;
wherein the charging body (400) is connected to the neck brackets (300); an outer part of each of the neck brackets (300) is a silicone housing (302), and an inner part of each of the neck brackets (300) is a memory steel wire (301); and the two charging heads (100) are connected to the charging body (400) through the connecting leads (200) passing through the neck brackets (300);
wherein each of the two charging heads (100) defines a structural cavity (107) and an earbud communication microphone channel; and the structural cavities (107) of the two charging heads (100) are configured to insert the wireless earbuds, respectively;
wherein each of the two charging heads (100) comprises a structural body (101), charging contact terminals (102), a first printed circuit board (103), a second printed circuit board (104), a charging indicator lamp (105), and a dust-proof screen (106); the structural body (101) comprises a silicone sleeve (1011), a first connector (1012), a second connector (1013), and a plastic base (1014);
wherein the charging contact terminals (102) are welded on the first printed circuit board (103); the first printed circuit board (103) is disposed on an upper end of the second connector (1013); the charging contact terminals (102) insert into an installing position (10121) of the first connector (1012), and the charging contact terminals (102) are configured to be connected to charging contact points of the respective wireless earbud; the charging indicator lamp (105) is welded on the second printed circuit board (104), and the second printed circuit board (104) is disposed on a lower end of the second connector (1013) and located inside the second connector (1013); an end of each of the connecting leads (200) extends into a corresponding one of the two charging heads (100); and a welding wire (201) of each of the connecting leads (200) is welded to the first printed circuit board (103) and the second printed circuit board (104) of the corresponding charging head (100); the other end of each of the connecting leads (200) is connected to a printed circuit control board (402) of the charging body (400) to charge a corresponding one of the wireless earbuds; and
wherein the first connector (1012) defines two first sound channel through-holes (1021); the two first sound channel through-holes (1021) are configured to be connected to a microphone of the corresponding wireless earbud; the second connector (1013) defines two second sound channel through-holes (1022), and the two second sound channel through-holes (1022) are directly connected to the two first sound channel through-holes (1021) respectively; the two second sound channel through-holes (1022) extend to a lower part of the second connector (1013) to define sound channel ports (1024) respectively; the sound channel ports (1024) are matched with the dust-proof screen (106); the plastic base (1014) defines a third sound channel through-hole (1023), and the sound channel ports (1024) are directly connected to the third sound channel through-hole (1023); and the two first sound channel through-holes (1021), the two second sound channel through-holes (1022), and the third sound channel through-hole (1023) are interconnected to define the earbud communication microphone channel.

2. The wearable power supply for the wireless earbuds as claimed claim 1, wherein the upper end of the second connector (1013) defines a first printed circuit board installing position (10131), and the lower end of the second connector (1013) defines a second printed circuit board installing position (10132) located inside the second connector (1013).

3. The wearable power supply for the wireless earbuds as claimed claim 1, wherein the plastic base (1014) further defines a light guiding position (10141) corresponding to the charging indicator lamp (105) welded on the second printed circuit board (104).

4. The wearable power supply for the wireless earbuds as claimed claim 1, wherein the first connector (1012) is disposed below the silicone sleeve (1011) and shaped by a mold; an inside of the silicone sleeve (1011) and an inside of the first connector (1012) together define the structural cavity (107) configured to insert the respective wireless earbud; an upper opening of the silicone sleeve (1011) defines a thin silicone opening position (108) and a thick silicone opening position (109); the thin silicone opening position (108) is configured to correspond to an earbud sensing button; and the thick silicone opening position (109) is configured to enhance insertion of the respective wireless earbud.

5. The wearable power supply for the wireless earbuds as claimed claim 1, wherein the charging body (400) comprises the printed circuit control board (402), a battery (401), power display lights (403), a charging button (404), a charging interface (405), and an alarm (406); the power display lights (403), the charging button (404), the charging interface (405), and the alarm (406) are disposed on the printed circuit control board (402); and the printed circuit control board (402) is electrically connected to the battery (401).

6. The wearable power supply for the wireless earbuds as claimed claim 1, wherein a usage method of the wearable power supply is to wear the wearable power supply on a neck; a material of the memory steel wire (301) is titanium alloy with a memory function; and the memory steel wire (301) is configured to combine with a lever fulcrum on a back of the neck according to human engineering, thereby achieve the usage method of the wearable power supply.

7. The wearable power supply for the wireless earbuds as claimed claim 5, wherein the alarm (406) is a buzzer or a vibration motor.

8. The wearable power supply for the wireless earbuds as claimed claim 1, wherein models of the wireless earbuds comprise: AirPods1®, AirPods2®, AirPods3®, AirPods Pro1®, and AirPods Pro2®.
